(19) United States
(12) Patent Application Publication
(10) Pub. No.: US 2002/0057626 A1
(43) Pub. Date: May 16, 2002

(54) Upstream seal for mixer rotors

(76) Inventors: Harold L. Schafer, Lehighton, PA (US); Kelly A. Ziegenfus, Jim Thorpe, PA (US); Donald E. Woodring, Tamaqua, PA (US)

Correspondence Address: ARTHUR R. EGLINGTON, ESQ., 113 Cross Creek Drive RD # 5, Pottsville, PA, 17901, US

(21) Appl. No.: 10/042,678

(22) Filed: Jan. 11, 2002

Related U.S. Application Data
(63) Continuation-in-part of application No. 09/707,208, filed on Nov. 7, 2000.

(51) Int. Cl. B01F 15/00

(52) U.S. Cl. 366/331

(57) ABSTRACT

In the field of helical bladed rotors and their sealing assemblies, an improved upstream seal for mixer rotors is provided. It includes a bushing-like visco sleeve subassembly, a sleeve shaped metallic liner positioned abutting the visco sleeve; a sleeve-like, visco seal having first and second peripheries, a packing seal retainer, all configured to provide an annular-shaped inner chamber in which a, oil seal packing component and a fluid conduit located in the packing seal retainer component which provides a pneumatic air supply to the chamber containing the packing component, which serves to minimize hardening of the packing assembly by minimizing feed particulate material leaking into the upstream visco seal means.

This is an examinable patent application under Section 111 (a) submitted for a formal filing receipt. This is a continuation-in-part of my copending provisional specification of Nov. 7, 2000, accorded U.S. Ser. No. 09/707,208.

### FIELD OF THE INVENTION

The present invention lies in the field of helical bladed, rotors and their sealing assemblies on the drive end of the rotors serving as continuous mixers for plastic materials.

### BACKGROUND OF THE INVENTION

The present invention relates to the operating problems encountered with sealing arrangements for a rotatable shaft, like a helical rotor. During rotor turning, a sealing pressure is built up and maintained in the molten materials as enclosed within the annular clearances provided between the rotors and the surrounding barrel by means of the helical ridges moving within the mixer. The current practice for a drive end journal, or rotor pilot component, requires a packing gland seal means to effect a compression on the packing component itself, so that its seals against an outer wear sleeve. The currently accepted sealing means is effective for only a relatively short time. This occurs because the particulate feed materials, and in their thermoplastic forms, work their way into the seal assembly itself. This then serves to harden the packing component, eventually to the extent that it appreciably stiffens, and the packing will no longer seat tightly against the wear sleeve. The positive air pressure in the mixer will cause the leaking of particulates to flow through the impaired sealing means, creating mixer site contamination, impacting worker cleanliness, and risking operating safety.

Accordingly, it is a principal object of the invention to provide a pneumatic visco sealing means in which particulate and molten materials do not bleed through the sealing means so as to generate site contamination.

It is another object to maintain the required sealing pressure at desired speeds of helical rotor rotation.

Yet another object of the invention is to eliminate any air pressure leakage from the mixing cylinder upon startup until the working area is loaded with molten material and/or particularly feed.

A still further object of the invention is to reduce seal area wear and packing seals degeneration so as to extend the operational range for a given sealing means assembly.

### SUMMARY OF THE INVENTION

According to the invention, there is provided in a continuous mixer apparatus adapted for comingling of particulate thermoplastic materials of varying polymeric compositions, having a mixer barrel, at least one main rotor with a helical profile body section, a driven journal located at the opposite end, a drive end rotor pilot component, a drive end packing seal retainer, a drive end visco seal assembly, and a packing gland seal means, further comprising a sleeve assembly, a metallic liner adjacent the sleeve assembly, a circular visco seal, an oil seal packing component disposed about the periphery of the visco seal, and an oil seal packing seal retainer component for the sleeve subassembly adapted for compressing the packing component, the improvement being made in the oil seal retainer component which comprises: (a) an annular channel provided substantially centrally of the inner periphery of the seal retainer component being defined by the component inner periphery and the opposing outer periphery of the visco seal; (b) an at least one elongate fluid conduit adapted for pneumatic air supply to the seal retainer component connecting between the annular channel and the outer periphery of the visco seal; and, (c) a means for supply of pneumatic air to the external end of the fluid conduit..

### BRIEF DESCRIPTION OF THE DRAWINGS

FIG. 1 is a side elevational view of a conventional compact processor for plastic particulate materials comprising a unitized particulate mixing and extrusion system, wherein particulate plastics are mixed, liquified and the resulting molten materials are pelletized for later molding into useful articles;

FIG. 2 is an enlarged, vertical view of the processor of FIG. 1, taken along lines 2-2 in FIG. 1, depicting a parallel set of material mixing assembly rotors, positioned within the compact processor of FIG. 1;

FIG. 3 is a broken away, enlarged vertical view of the drive and assembly of the mixing components of a processor of FIG. 1, wherein a drive end, prior art, packing gland seal configuration is depicted;

FIG. 4 is another broken out, enlarged vertical sectional view of the drive end, packing gland seal means configuration but now of the present invention;

FIGS. 5A and 5B are side elevation, and end elevational, views, respectively, of the visco sleeve assembly bushing of the present invention, as employed on the present visco assembly of FIG. 4;

FIGS. 6A and 6B are side elevation and end elevation views, respectively, of the sleeve-like, circular sealing component of the present invention for the left hand rotor of FIG. 2;

FIGS. 7A and 7B are side elevation, and end elevation, views, respectively, of the packing seal of the present invention;

FIG. 8 is an exploded perspective view, illustrating the several components, both standard and novel, which comprises the improved drive end, visco seal assembly of the present invention;

FIG. 9 is another vertical sectional view of an alternate embodiment (MA061) of the improved packing gland seal means of FIG. 4, but now modified to include a pneumatic air input component for continuous air purging of the visco seal assembly packing gland means of this invention.

FIG. 10 in an exploded perspective view illustrating the packing seal components (MA061), both standard and novel, which comprise the air purging embodiment of the viscous seal assembly of the present invention.

FIGS. 11A/B (prepared from ICPMP059) are a side elevation, and end elevational views, respectively, of the modified air input seal housing 68B which serves as a oil seal retainer component of the present invention.

FIGS. 12 A/B (ICPM060) are a side elevational, and end elevational views, respectively, of the pneumatic visco sleeve composition which abuts tightly the seal house of FIGS. 11A/B.

FIG. 13 is a schematic elevational view of the air supply assembly panel which feeds and regulates the flow of pneumatic air to the air input housing of FIG. 10.

### DETAILED DESCRIPTION OF THE PREFERRED EMBODIMENT

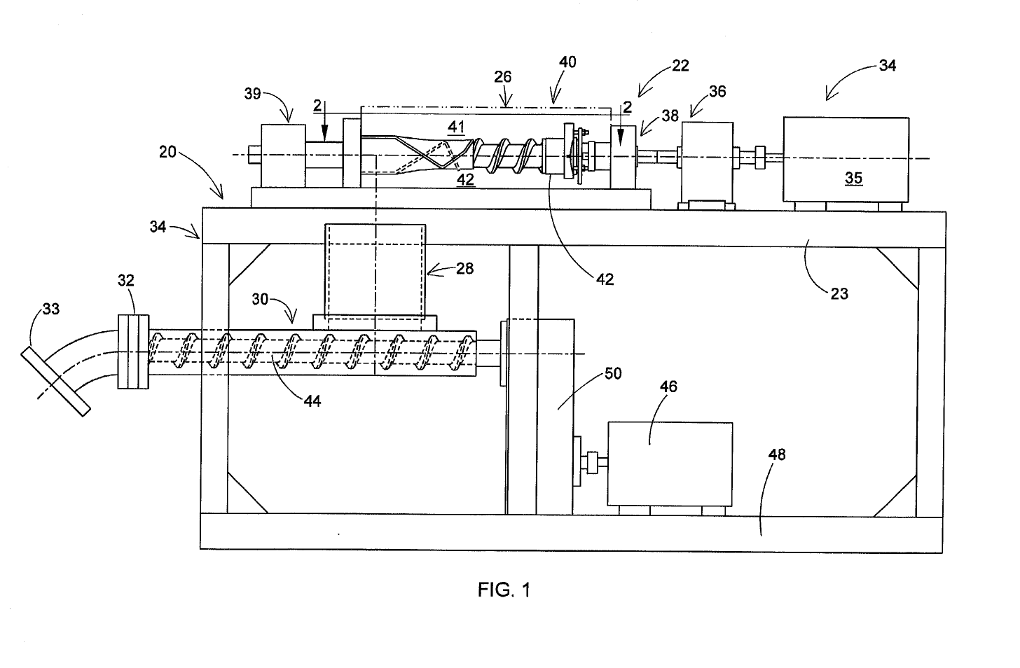

With reference to FIG. 1, there is shown a compact processor 20 for plastic materials and comprising a unitized mixing and extrusion system that allows a user to customize mixing and extrusion of plastic materials being processed. This unitized processor system comprises a two-rotor, continuous mixer 22 mounted on an upper level 23 of a framework 24. Plastic materials, fillers, additives, colorants, and the like, as desired by the user, namely various ingredients desired to be mixed with plastic materials, are introduced into a feed entrance (sometimes called a “feed throat”) of the continuous mixer 22, as indicated by an arrow 26. The resulting molten plastic materials flow by gravity down from the continuous mixer 22 like a molten “rope”, descending within a vertical chute 28, into a hot-feed extruder 30. The output from the extruder 30 issues through an extruder head 32 adapted to have various types of an extrusion device 33 mounted thereon, as may be desired by the user.

For driving the two rotors in the mixer 22, there is shown a suitable drive system 34, for example, such as a d.c. drive motor 35 arranged with suitable feedback speed and torque controls, as known in the art, for turning the mixer rotors preferably at predetermined constant speed. This motor 35 is coupled to a suitable speed-reducer 36, for example such as an all helical gear, speed-reducer with two output shafts coupled to two three-piece rotors for rotating the two rotors in opposite directions about their respective longitudinal axes. In this illustrative example, the two rotors are turned in opposite directions at the even/or ratio rates.

The mixer 22 includes a drive end frame 38 (also called a “drive bearing housing assembly”) for rotatably supporting a drive end journal (not seen in FIG. 1). This drive end frame 38 and its journal will be described in detail later. The mixer includes a driven end frame 39 “which may be called the “water end frame” and also may be called “driven bearing housing assembly”) for rotatably supporting a driven end journal (not seen in FIG. 1). The driven end, frame 39, and its journal, also will be described in detail later. Mounted between drive and driven end frames 38, 39 is a mixer chamber barrel, or housing 40, including an upper half 41 and a lower half 42.

For driving an extruder feed screw 44 (FIG. 1) in the hot-fed extruder 30, there is shown an electric motor 46 mounted on a base 48 of framework 24. This motor 46 is coupled through a suitable speed-reducer transmission 50 to the extruder screw 44.

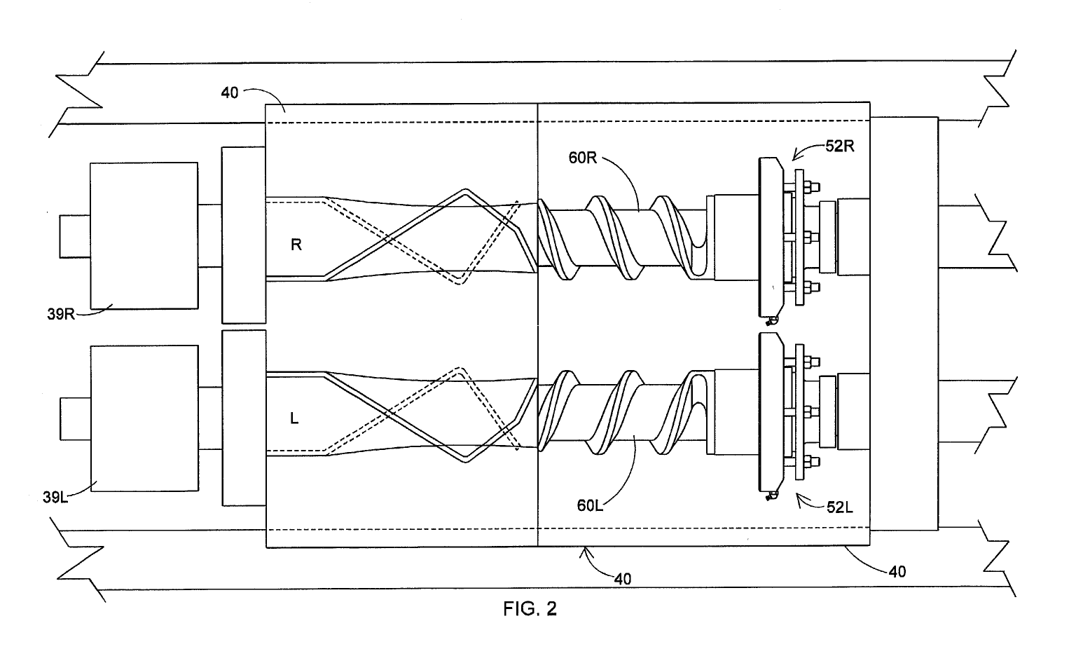

Looking to top plan view of FIG. 2, with upper barrel half 41 removed, there is shown a pair of parallel rotors, 60L/R, both positioned horizontally within housing 40, and which are denominated left and right hand mixing rotors, respectively. The left-hand, longitudinal ends of the mixing rotors are mounted conventionally in journals at the drive end, frame 38, while the drive ends each have a packing seal assembly, generally 52L/R, respectively, to be described, in connection with FIGS. 4, et seq. The other longitudinal ends of the paired rotors are mounted in driven ends of the housing frames, 39L/R (FIG. 1).

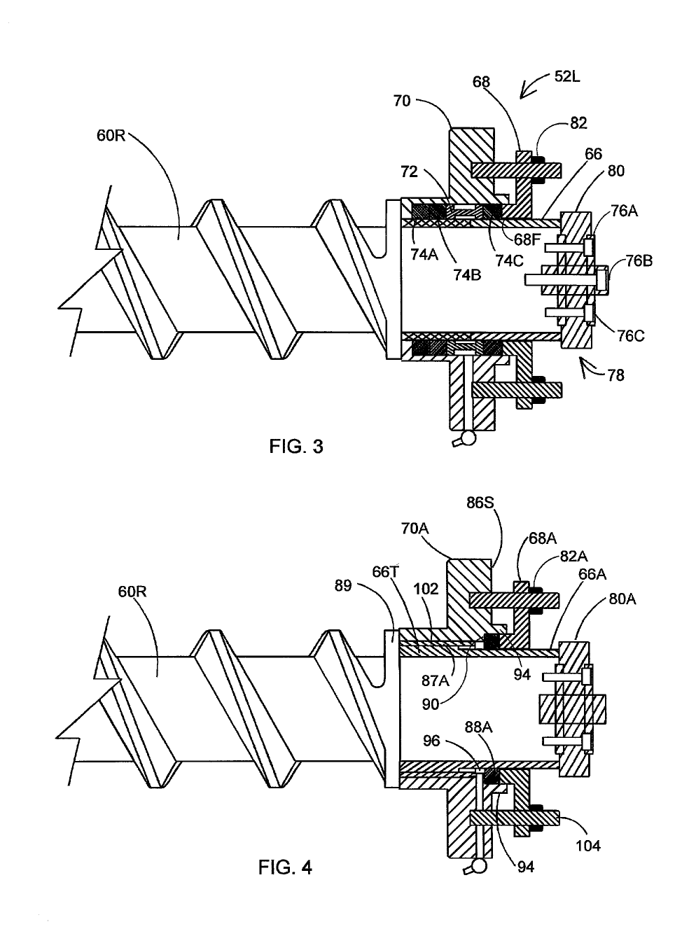

Reference will now be made to FIG. 3 to describe a state of the prior art device regarding drive end, packing seal assemblies, employable in connection with the compact processor for plastic materials, schematically seen in FIGS. 1 & 2. Axially mounted to the drive end 38 of right hand, helical rotor 60R is the drive end, packing seal assembly, generally 52R. It comprises: an inner, collar-like. wear sleeve 66; an L-shaped, packing seal retainer 68; a bushing-like, packing housing 70; and an alignment ring 72, which separates three rope-like, packing components, 74A, 74B, and 74C; the subassembly 78 at the free outer end comprises rotor pilot, plate 80; and associated bolts and washers, 76A, B, C which clamp that describes parts in a working relation; the horizontal flanged element 68F of seal retainer 68 is biased inwardly, via its lock nut 82 against the set of rope packings 74. These serve to expand same radially against the circular periphery of wear sleeve 66.

Experience has shown that the particulate material, while in process, infiltrates into the just-described sealing arrangement, thereby hardening this packing set, generally 74. This progresses to the extent that they will not properly seal against wear sleeve 66. This time developing defect causes feed particulate to leak about the wearing sleeve 66 periphery. When the leakage contamination levels reach appreciable levels, the mixer must be shut down, and all the just-described packing seal elements are disassembled, so as to permit replacement of the three rope packing rings, the intermediate alignment ring and the wear sleeve.

Looking now to the vertical sectional view of FIG. 4, a structurally modified and improved visco sealing assembly of the present invention is depicted. Several of the components are continued modified, such as the rotor pilot plate 80A, and the seal retainer 68A, but the alignment ring 72 is now omitted. The sleeve assembly 70A, the wear sleeve 66A, and the packing component 88A themselves, are significantly reconfigured for superior visco sealing. Sleeve assembly 70A is now provided along its inner circumferential surface with an integral, continuous peripheral ridge 90, which ridge is located quite proximal to the longitudinal end, of sleeve assembly sidewall 86S, and is distal from the adjoining right hand, rotor 60R/L flanged end 89. A second circular, axially projecting ridge 94 is provided upon the sleeve assembly sidewall 86S, and is contiguous (conjoined) with the inner peripheral ridge 90 thereof.

An annular chamber 96 of squared cross section, is defined by bushing-like, sleeve assembly 70A; ridge 94; ridge 90, wear sleeve 66A, and packing seal retainer 68A. These elements provide the functional recess for a single rope packing component, 88A. Offset, but linearly aligned with chamber 96, is the annular chamber 87A of an elongate rectangular cross section defined by the opposing circumferential periphery of assembly 70A and drive end visco seal wear sleeve 66A. This annulus-shaped recess 87A accommodates the metal liner 102 of the present invention, which liner demonstrates prolonged effectiveness during mixing and extrusion. The novel heat resistant, liner 102 of the present invention is preferably composed of bronze.

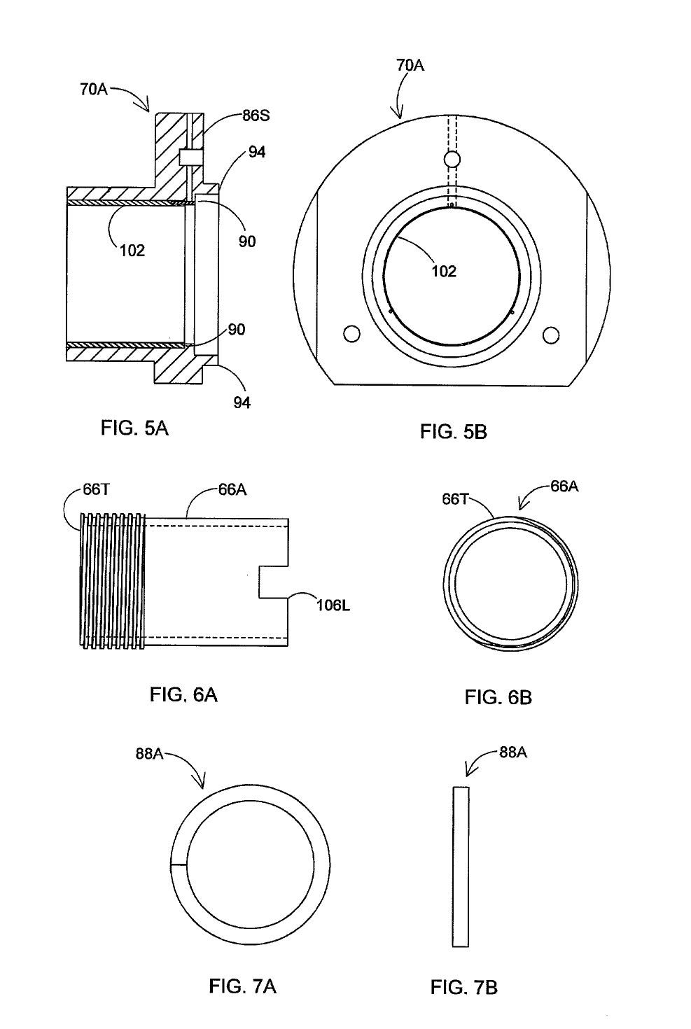

The side and end elevational view of FIGS. 5 A/B, depict the dimensions of the somewhat modified bushing-like, sleeve assembly 70A with sleeve 102 in place; while the side and end elevation views of FIGS. 6A/B depict the right hand, visco wear sleeve seal 66A. Note that the inwardly oriented, circular ridge 90 on bushing 70A provides lateral support to the inward edge of sleeve liner 102. The sleeve seal 66A has a peripherally threaded segment 66T proximal to the one longitudinal end. This latter sleeve component is known in the art as a standard element for visco seals, which was described in expired U.S. Pat. No. 3,963,247, of Jun. 15, 1976 to Nommensen.

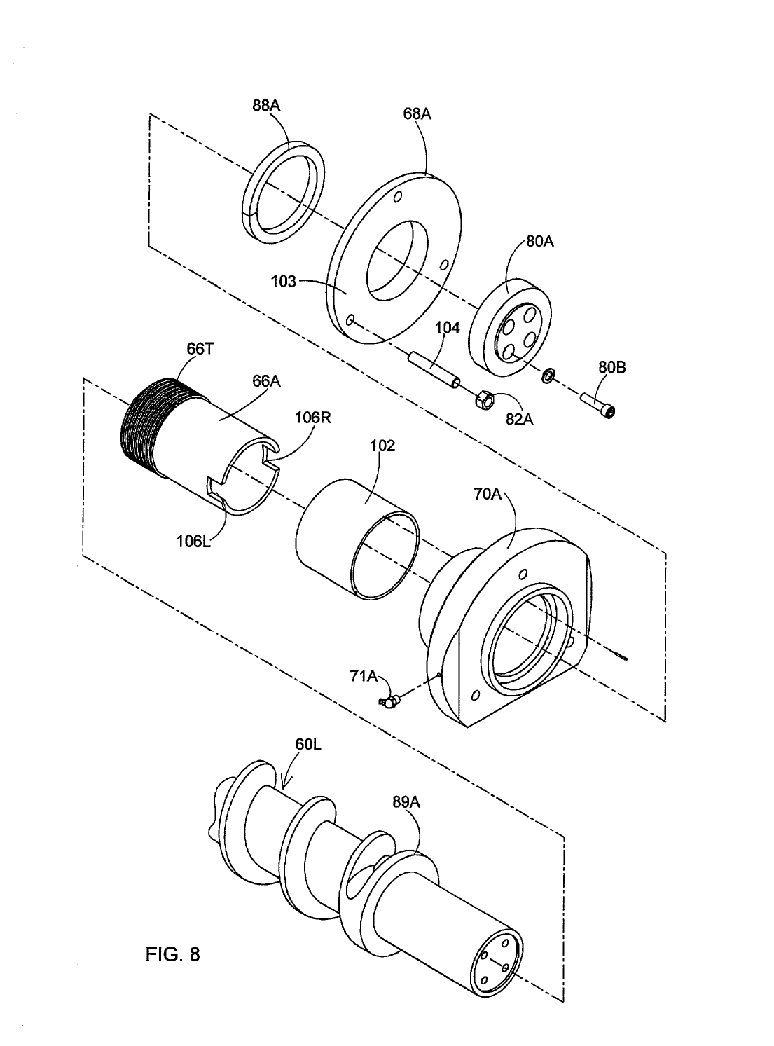

In the end elevational view and side elevational view of FIGS. 7A and 7B, the circular, ring-like, configuration resilient of packing 88A is depicted.

Looking now to the exploded perspective view of FIG. 8, which depicts all of the operative components aligned pre-assembly, opposing lower edge, 103, of seal retainer 68A, has a set screw 104, which screw serves to retain packing 88A in abutting relationship with inward oriented, circular ridge 90 of sleeve assembly 70A with grease fitting 71A.

Two diametrically opposed, squared notches, 106L/R, are provided in the circular rim 106 of drive end visco sleeve 66A which extends outwardly of the one longitudinal end. These serve to key the alignment of the sealing component within the drive end subassembly 52L (right hand rotor shown) of FIG. 2.

Selected spaced-apart sealing elements, to wit, L-shaped seal retainer 68A, bushing-like sleeve assembly 70A, dual circumference, visco seal 66A, and rope packing 88A, comprise the modified elements of the drive end, improved visco seal means of the present invention.

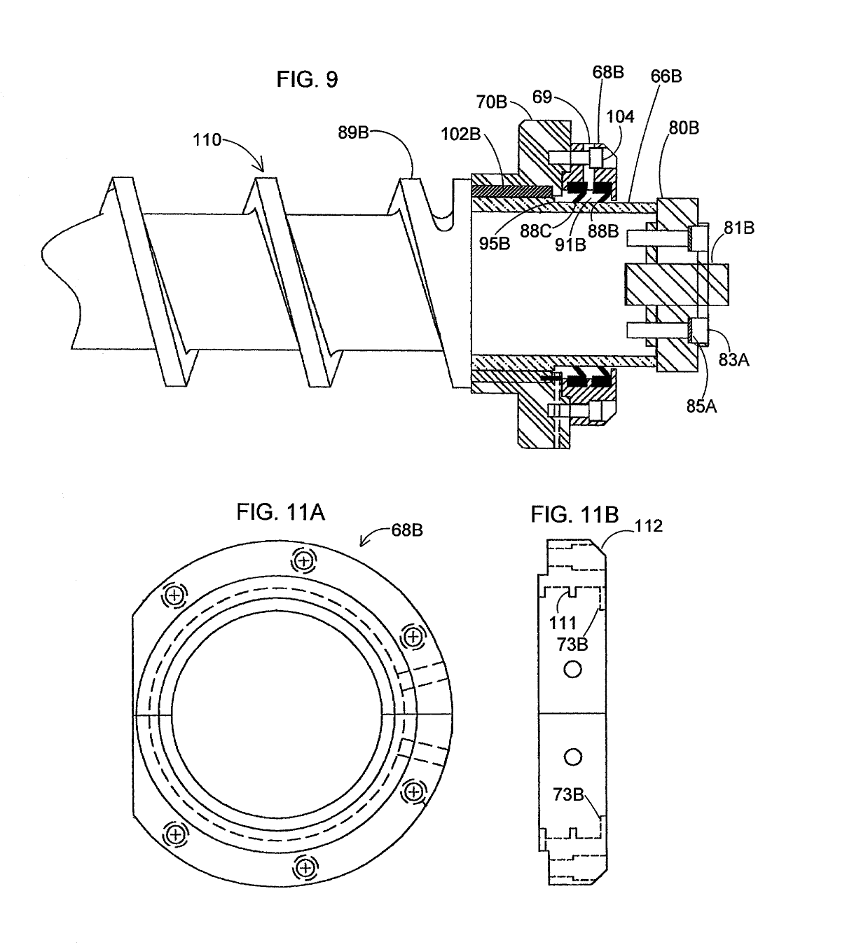

Looking now to the vertical sectional view of FIG. 9, an improved visco seal assembly, generally 110, is further adapted to provide an air purge feature with an oil seal means. This ancillary sealing feature serves to enhance the assembly ability to keep plastic and powder material from exiting the mixer body (FIG. 2) on the upstream side of the machine.

Some of the components are continued unmodified, such as flanged pilot rotor at 89B, wear sleeve 66B, and liner 102B, but seal housing 68B, packing components 88B/C, screw-type fasteners 104B, and visco sleeve 70B are all modified to provide for the air purge feature of enhanced superior visco sealing. The seal housing 68B encloses abutting new oil seal packings, 88B/C, with pneumatic air being introduced between the oil seals, as will be described. At least one port 69 is positioned radially within the sidewall of seal house 68B. It interconnects between an external pneumatic air supply (FIG. 13) and an annulus-shaped chamber 91B provided on the inner periphery of seal house 68B.

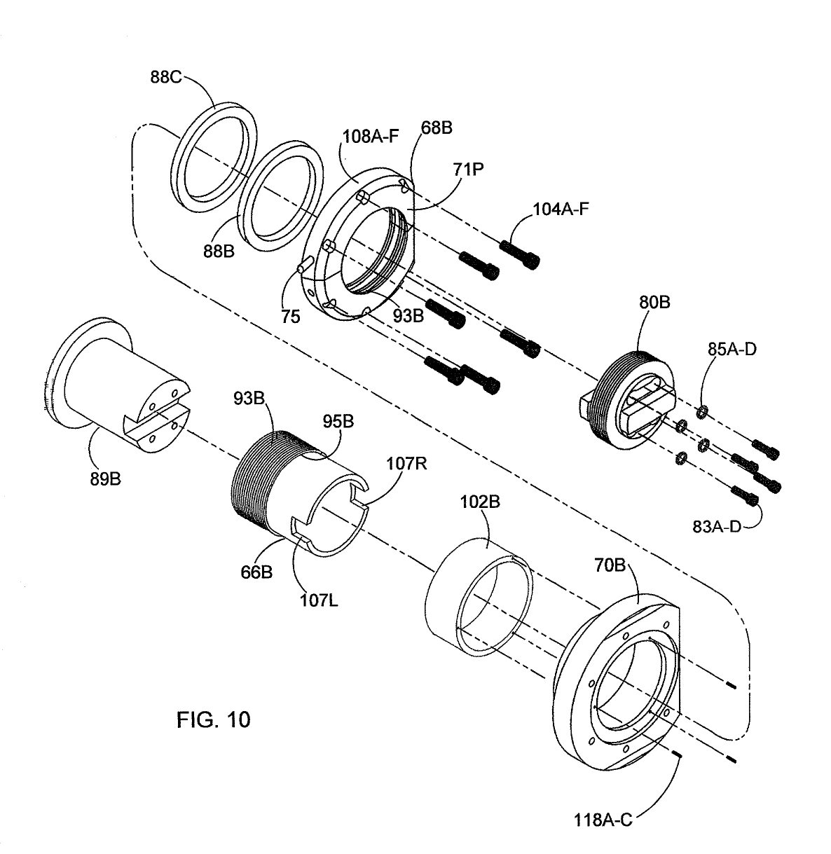

In the exploded view of FIG. 10, it will be evident that components 89B, 66B, 102B, rotor pilot 80B are configured as in the embodiment of FIG. 8. However, seal retainer 68B, visco sleeve 70B, and packing rings 88B/C, are substantially modified. Also in this embodiment, dual, abutting oil seals are employed, while seal house 68B for the oil seals is provided with one planar segment 71P for its generally circular outer periphery. The purpose of this planar segment is to provide an abutting surface for the companion rotor 60R described above in connection with FIG. 2 (not seen). This is needed so that the dual packing seal housings 68B will align with the pilot rotors. Rotor pilot plate 80B seats upon the outer circular periphery of visco seal 66B.

Liner 102B encloses the driven end, periphery of the visco seal 66B, while the inner surface of flanged visco sleeve 70B abuts and engages the outer periphery of liner 102B. Ring-like, seal house 68B abuts laterally upon visco sleeve 70B, while its inner periphery defines an annulus-shaped chamber 91B, which chamber receives and retains, paired resilient oil seals, 88B/C. The outer lateral surface 73B of seal house 68B has an edge 73B, which is somewhat spaced apart from the outer periphery of visco seal 66B. (See FIG. 11B.)

A nipple 75 is threaded into seal house port 69 (FIG. 9) providing the point of connection for a pneumatic air supply (not seen) which is fed in inner periphery chamber 91B of house 68B.

The outer oil seal 88B is configured (with a depending flap) so that pneumatic air is arrested from escaping to the atmosphere, thus maintaining pneumatic pressure. The inner oil seal 88C is configured (also with a depending flap) so as to retain polymeric “dust” within the mixer body (FIG. 2). Consequently, the air flow into seal house chamber 91B, is positive such that the air flow, by pushing powder material into the mixer machine, serves to greatly enhance the of the capacity of the seal to preclude powder material from escaping the mixer body on the upstream side of the packing gland means of the invention.

Also, in the exploded view of FIG. 10, the configuration of the modified components can be better seen. There are: externally threaded rotor pilot 80B with associated washers 85A-D and fasteners 83A-D, left-hand seal house 68B, to engage rotor pilot 80B, and which seal house is also truncated vertically so as to abut the adjacent seal house (not seen); bolts 104A-F which serve to affix the seal house 68B to visco sleeve 70B; paired oil seal rings 88B/C; visco seal member 68B, inner periphery 93B.

Sleeve-like circular liner 102B engages the threaded outer periphery of visco seal 66B, by riding on the top thereof, with seal 66B mounting on the drive end 89B of the rotor shaft.

The pneumatic seal house 68B of FIG. 10 is seen in the isolated end, and side, respectively, elevational views of FIGS. 11A/B. Tapped transverse bores 108A-F receive the bolts 104 (FIG. 10). Note especially a peripheral annular ridge 111 which serves to space apart and to retain the oil seals, 88B/C, of FIG. 10. The external chamfer 112 is provided on the external edge of component seal house 68B. Note also the depending circular flange 73B which defines a chamber 93B in assembly.

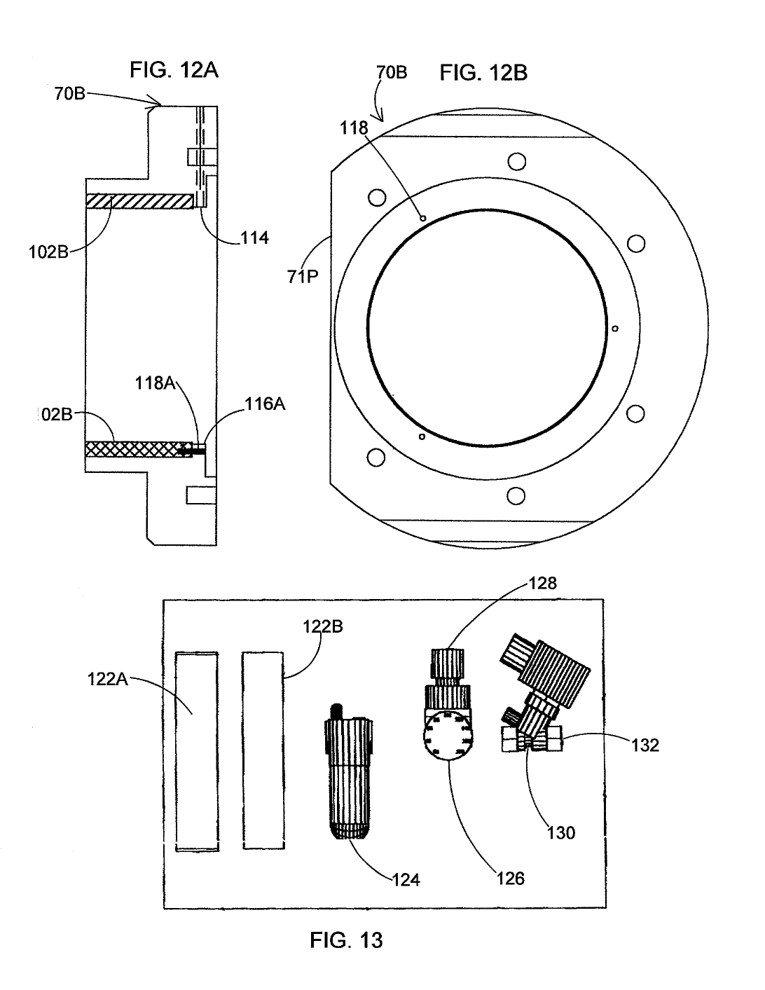

The pneumatic visco sleeve 70B component is seen in the isolated end, and side elevational views of FIGS. 12A/B. Note the outer counter bore 114 on the inner circular periphery of the sleeve 70B which receives and retains liner 102B. A set of three set screws, 116A/C, serve to engage recesses 118A-C in the forward edge of liner 102B. These pins function to preclude liner 102B rotation relative to the enclosing visco sleeve 70B. The aforementioned assembly components are those common to the embodiments of FIG. 4, but which have now been adapted to provide for the operating advantages of a pneumatic air purging system for the improved mixture apparatus of the present invention.

The ancillary pneumatic air supply assembly 120 is depicted schematically in FIG. 13. It includes dual air flow meters 122A/B, lubricator 124, air pressure gauge 126, regulator 128, solenoid 130 and connecting nipple 132. This air supply system is operatively connected from a user air supply (not shown) to the nipple 75 of seal house 68B. The depicted assembly is typical, but not exclusive, of the varied means that can be employed for improving the operational efficiency of the packing seal retainer component for a continuous mixer apparatus.

1. In a continuous mixer apparatus adapted for comingling of particulate thermoplastic materials of varying polymeric compositions, having a mixer barrel, at least one main rotor with a helical profile body section, a driven journal located at the opposite end, a drive end rotor pilot component, a drive end, packing seal retainer, and a drive end visco seal assembly, and a packing gland seal means, further comprising a sleeve assembly, a metallic liner adjacent the sleeve assembly, a circular visco seal, an oil seal packing component disposed about the periphery of the visco seal, and an oil seal packing seal retainer component for the sleeve subassembly adapted for compressing the packing component, the improvement being in the oil seal retainer component which comprises:
(a) an annular channel provided substantially centrally of the inner periphery of the seal retainer component being defined by the component inner periphery and the opposing outer periphery of the visco seal;
(b) an at least one elongate fluid conduit adapted for pneumatic air supply to the seal retainer component connecting between the annular channel and the outer periphery of the visco seal; and,
(c) a means for supply of pneumatic air to the external end of the fluid conduit..

2. The improved packing seal retainer of claim 1 wherein the each packing component has a substantially squared cross section.

3. The improved oil seal retainer of claim 1 wherein each seal component is of a material selected from one of the fluoroelastomers with a repeating structure —CF₃—CH₂—CF₂—CF(CF₃)—(VITON).

4. The oil seal retainer component of claim 1 in which the inner periphery thereof is adapted to receive the outer flat surface of the visco seal so that the oil seal components can ride thereon.

5. The packing seal retainer component of claim 1 wherein the outer peripheral thereof is provided with a truncated segment presenting a planar surface adapted to abut the companion seal retainer.

6. The packing seal retainer component of claim 1 wherein the mated seal house and opposing visco seal components are configured so as to provide an annular-shaped, port about the drive end sub-assembly, whereby a positive air pressure supply can be directed from an external source to the sealed retainer annular channel, so as to provide for continuous fluid air purgation of the drive end, visco seal assembly in operation.

7. The seal retainer component of claim 1 wherein the fluid conduit is aligned radiaclly within the seal house member of seal retainer component.

8. In a continuous mixer apparatus adapted for commingling of particulate thermoplastic materials of varying polymeric compositions, and having a mixer barrel, at least one main rotor with a helical profile body section at one end thereof, a driven journal located at an opposite drive end thereof, a drive end rotor plate, a drive end packing seal retainer, and a packing gland seal means at the drive end, the improvement in the packing gland seal means which comprises:
(a) a bushing-like, visco sleeve assembly having a cylindrical inner surface being provided with an integral continuous, first peripheral annular ridge located proximal to one longitudinal end of the sleeve assembly, which one end is distal from the helical profile body;
(b) a double, oil seal sleeve-shaped, metallic liner positioned adjacent the inner periphery of the sleeve assembly;
(c) a sleeve-like, circular visco seal, being stepped-down intermediate the ends thereof having first and second cylindrical peripheries, with the lesser diameter, periphery seal being located distal from the helical profile body section, and with the larger diameter periphery seal being provided with a visco seal threading, and with the sleeve assembly and circular visco seal defining an annulus-type inner chamber therebetween;
(d) a single, rope-like first packing component positioned about the visco seal periphery and abutting the annular ridge of the sleeve subassembly; and
(e) said oil seal retainer being L-shaped and positioned adjacent the sleeve subassembly and also abutting and compressing laterally the first oil component.
